(19) United States
(12) Patent Application Publication
(10) Pub. No.: US 2018/0283617 A1
(43) Pub. Date: Oct. 4, 2018

(54) METHODS FOR INTRODUCING ISOLATORS INTO OIL AND GAS AND LIQUID PRODUCT PIPELINES

(71) Applicant: Naveed Aslam, Houston, TX (US)

(72) Inventor: Naveed Aslam, Houston, TX (US)

(21) Appl. No.: 15/474,157

(22) Filed: Mar. 30, 2017

(51) Int. Cl. F17D 3/08; F16L 55/38

(52) U.S. Cl. CPC F17D 3/08; F17D 1/00; F16L 55/38

(57) ABSTRACT

A method for separating two or more different gases that are being transported in a pipeline is described. A slug of inert gas, particularly nitrogen is introduced between the two or more different gases to replace the isolators that have been traditionally used. This slug of inert gas will assist in more efficiently transporting the gas while reducing the problems associated with isolators. There is further disclosed a method for separating and transporting at least two liquid products such as two different crudes or diesel and gasoline in a pipeline.

### BACKGROUND OF THE INVENTION

Long distance pipelines that carry natural gas when being commissioned will need to have the air in the pipe replaced by natural gas. This will assist in reducing the risk of explosion in the pipeline.

Some methods for commission include using two isolators, namely air and nitrogen and natural gas with a spacer in between the three zones. Alternatively, a spacer is disposed between the air and nitrogen to isolate them.

These isolator methods can be less efficient when encountering factors in the design of the operation such as pipe strengths not being the same; inner diameter of the pipeline changing over the length of the pipeline; bends in the pipe segment as well as roughness of the inside of the pipeline.

As gas consumption increases, natural gas pipelines are progressing towards larger diameters and longer distances. Naturally, the concerns with commissioning them for natural gas delivery are still present and they must be so treated before being filled with product for delivery.

To that end, the present invention is directed to the use of an inert gas and isolator for purposes of commissioning pipeline operations while reducing the risk of explosion. To provide this safety, an isolator is commonly employed to separate the nitrogen and air.

### SUMMARY OF THE INVENTION

In a first embodiment of the invention there is described an improved method for transporting at least two gas products through a pipeline, the improvement comprising introducing a slug of inert gas between the at least two gas products.

In a second embodiment of the invention, there is described a method for transporting at least two gas products through a pipeline comprising introducing a slug of nitrogen between the at least two gas products.

In another embodiment of the invention there is disclosed a method to transport and isolate at least two liquid products in a pipeline. The at least two liquid products can be different liquid products or at least two grades of the same liquid product.

The prior art isolators were typically pigs which could be made of foam, polyurethanes or meals such as steel with certain components made from softer materials.

The methods of the present invention can be practiced in both liquid and gas pipelines. In the case of liquid pipelines, the methods could be employed for both oil as well as other liquid product pipelines. When the pipeline is an oil pipeline, different crudes or different finished fuel products which can even be from different companies can be transported using the methods of the present invention. For example, two different crudes could be transported, separated by the inert gas slug per the present invention. Alternatively, for example, diesel and gasoline could be the two liquids being transported in the pipeline.

The gas products that can be transported by the methods of the present invention are selected from the group consisting of natural gas, air, oxygen, synthesis gas and ethane.

Typically, two or more gases can be present in the pipeline and separated by the inert gas slug or isolator. Preferably two gases are present in the pipeline and separated by the inert gas slug or separator.

Alternatively, argon could be employed in place of nitrogen as the inert gas.

The inert gas is introduced between the at least two gas or liquid products by either injecting during flow of the gas or liquid products or at the beginning of the transporting of the two or more gas or liquid products.

The gases that are being transported will be removed from the pipeline based on the type of gas that is being removed. Different gases therefore will be directed to different vessels. The inert gas slug and air can be vented to the atmosphere in an environmentally sound manner while natural gas product can be fed to a pressurized cylinder or appropriate storage tank.

The gases that are transported in the pipelines can have lengths of 500 miles and often have lengths of 1000 miles or longer. For purposes of the present invention, the slug of inert gas can range from 0.5 miles in length to 10 miles in length depending upon the diameter of the pipeline, the outside temperature and operating pressure of the pipeline.

The gases that are being transported are generally introduced into the pipeline through a compressor or pressurized cylinder with a venturi nozzle to balance flow and generate the required flow patterns. Likewise, the inert gas slug may be introduced into the pipeline through a compressor or pressurized cylinder with a venturi nozzle.

The conditions for this introduction into the pipeline can range from 60 to 80 psig up to 400 to 1600 psig. Temperatures will typically be about room temperature of about 20° to 25° C.

The gases in the pipeline will typically travel at a speed of 3 meters/second to about 10 meters per second.

### BRIEF DESCRIPTION OF THE DRAWINGS

FIG. 1 is a schematic of a pipeline showing an isolator separating nitrogen and air in a pipeline.

FIG. 2 is a schematic showing two different gases passing through a pipeline.

FIG. 3 is a schematic showing several different gases separated by isolators in a pipeline.

FIG. 4 is a schematic showing several different gases being separated by nitrogen slugs in a pipeline.

### DETAILED DESCRIPTION OF THE INVENTION

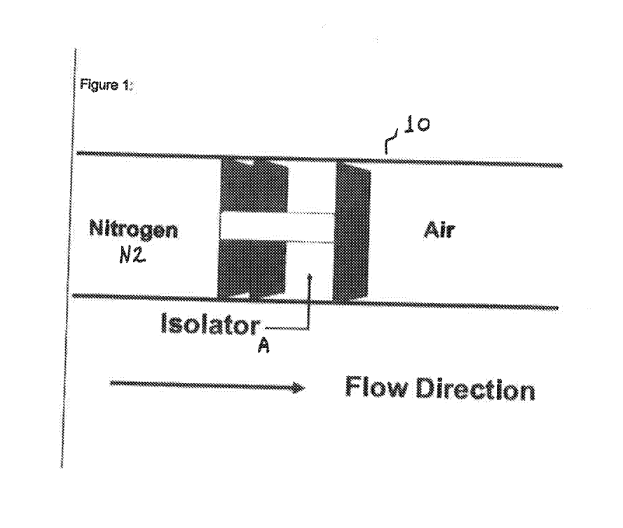

FIG. 1 shows an isolator that is firstly placed at the entrance of a pipeline before pumping the nitrogen. Nitrogen (N2) is fed in the flow direction indicated by the arrow into the pipeline 10. Air is present downstream from the N2 and is separated by an isolator A.

The nitrogen flow pushes the isolator A forward. Since the terrain through which pipelines are pass can be quite uneven from mountains to deserts to rough grounds and river deltas, the undulations make passing the isolator A through the pipeline 10 much more difficult. In larger diameter pipelines, the costs for isolators can be double that of smaller diameter pipelines. Further isolator seals can fail due to wear as well as getting stuck in the pipeline.

In the methods of the present invention, the isolator is replaced with inert nitrogen gas. The use of nitrogen gas rather than a physical isolator can result in saving as well as avoid some of the difficulties with undulations in the pipelines while eliminating the risks involved in isolators getting stuck or failing.

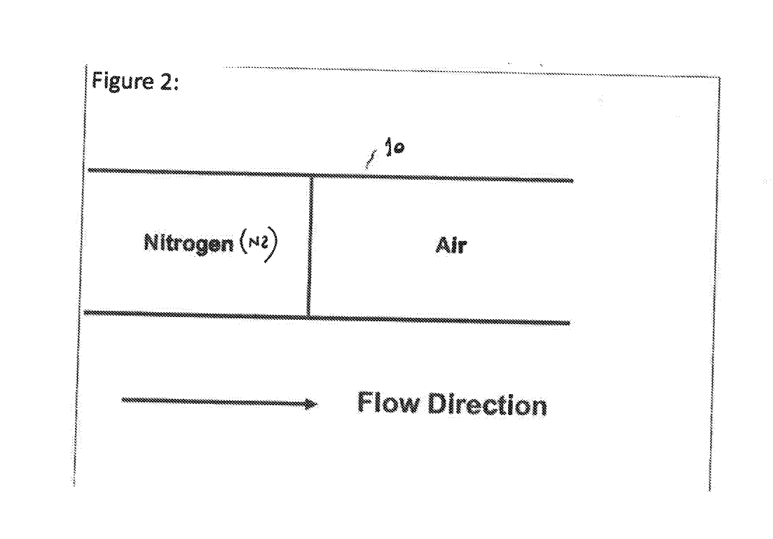

FIG. 2 shows the same pipeline 10 with a flow of gas in the direction of the arrow whereby nitrogen (N2) is used to replace the isolator. In this process the gas mixture length becomes a key parameter in determining the displacement of nitrogen.

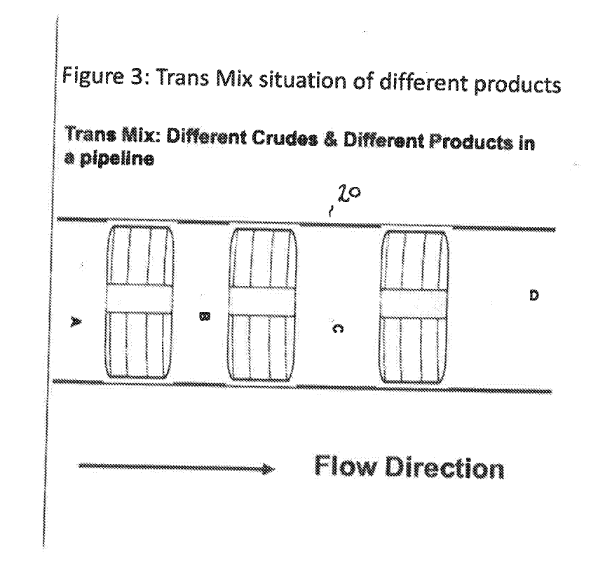

FIG. 3 shows a pipeline 20 which contains a number of different products A, B, C and D flowing in the direction of the arrow. The isolators 1, 2 and 3 are shown separating these different products.

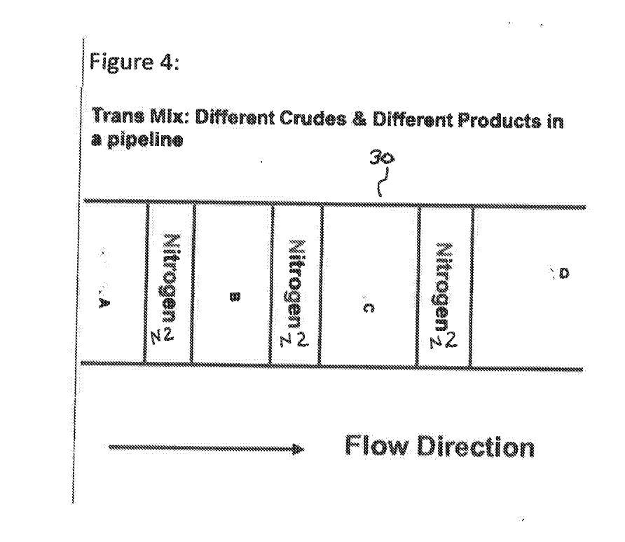

FIG. 4 shows the improvement to the isolator schematic described in FIG. 3. A pipeline 30 has a series of different products A, B, C and D travelling in the direction of the arrow. In this embodiment a nitrogen slug N2 will be placed between each of the different products A, B, C and D to act as an isolator thereby keeping the products at their proper concentration and specification for subsequent delivery and/or removal from the pipeline 30.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for transporting at least two gas products through a pipeline, the improvement comprising introducing a slug of inert gas between the at least two gas products.

2. The method as claimed in claim 1 wherein the at least two gas products are selected from the group consisting of natural gas, air, oxygen, synthesis gas and ethane.

3. The method as claimed in claim 1 wherein the inert gas is selected from the group consisting of nitrogen and argon.

4. The method as claimed in claim 1 wherein the at least two gas products are the same gas.

5. The method as claimed in claim 1 wherein the at least two gas products are different gases.

6. The method as claimed in claim 1 wherein the inert gas slug is introduced during flow of the at least two gas products.

7. The method as claimed in claim 1 wherein the inert gas slug is introduced prior to transporting of the at least two gas products.

8. The method as claimed in claim 1 wherein the inert gas slug is introduced into the pipeline through a compressor or pressurized cylinder with a venturi nozzle.

9. A method for transporting at least two gas products through a pipeline comprising introducing a slug of nitrogen between the at least two gas products.

10. The method as claimed in claim 9 wherein the at least two gas products are selected from the group consisting of natural gas, air, oxygen, synthesis gas and ethane.

11. The method as claimed in claim 9 wherein the at least two gas products are the same gas.

12. The method as claimed in claim 9 wherein the at least two gas products are different gases.

13. The method as claimed in claim 9 wherein the slug of nitrogen is introduced during flow of the at least two gas products.

14. The method as claimed in claim 9 wherein the slug of nitrogen is introduced prior to transporting of the at least two gas products.

15. The method as claimed in claim 9 wherein the slug of nitrogen is introduced into the pipeline through a compressor or pressurized cylinder with a venturi nozzle.

16. A method for transporting at least two liquid products through a pipeline comprising introducing a slug of inert gas between the at least two liquid products.

17. The method as claimed in claim 16 wherein the two liquid products are the same liquid product.

18. The method as claimed in claim 16 wherein the two liquid products are two different liquid products.

19. The method as claimed in claim 18 wherein the two different liquid products are two grades of the same liquid product.

20. The method as claimed in claim 16 wherein the inert gas is selected from the group consisting of nitrogen and argon.

21. The method as claimed in claim 16 wherein the inert gas slug is introduced during flow of the at least two liquid products.

22. The method as claimed in claim 16 wherein the inert gas slug is introduced prior to transporting of the at least two liquid products.

23. The method as claimed in claim 16 wherein the inert gas slug is introduced into the pipeline through a compressor or pressurized cylinder with a venturi nozzle.
